(19) United States
(12) Patent Application Publication
(10) Pub. No.: US 2007/0100690 A1
(43) Pub. Date: May 3, 2007

(54) System and method for providing targeted advertisements in user requested multimedia content

(76) Inventor: Daniel Hopkins, Scottsdale, AZ (US)

Correspondence Address: GREENBERG TRAURIG LLP, 2450 COLORADO AVENUE, SUITE 400E, SANTA MONICA, CA, 90404, US

(21) Appl. No.: 11/265,964

(22) Filed: Nov. 2, 2005

(51) Int. Cl. G06Q 30/00

(52) U.S. Cl. 705/14

(57) ABSTRACT

A method and system is disclosed for providing targeted advertising material in multimedia content to a user device via the internet. This method includes operations of receiving a request for multimedia content from a user device via the internet, determining geo-location information about the user device, and retrieving the requested media content along with user demographic information. The content included user demographic information is combined with the geo-location information about the user device to provide a user profile. Then at least a first advertisement database is queried for advertising material matching one or more characteristics of the demographic information about the user and/or the user profile. If there is a matching advertisement found, the matching advertising material is retrieved from the first database, and inserted into the retrieved media content. The retrieved multimedia content, along with the matching advertising material, is then transmitted to the requesting user device over/through the internet.

### BACKGROUND

1. Field

This disclosure relates to distribution of targeted advertising content and more particularly to targeted advertisement distribution with multimedia content obtained through the internet.

2. General Background

Advances in television entertainment have been primarily driven by breakthroughs in technology. In 1939, advances on Vladimir Zworykin's picture tube provided the stimulus for National Broadcasting Service (NBS) to begin its first regular broadcasts. In 1975, advances in satellite technology provided consumers with increased programming to homes.

Today, the opportunity to distribute television and radio content over the internet is fast becoming a serious consideration. However technology limitations exist in providing a profitable advertising model in distributing television content over the internet. Advertising forms an important part of broadcast programming and radio. The revenues generated from advertisers subsidize, and in some cases pay entirely for, programming received by subscribers. For example, over the air broadcast programming is provided entirely free to viewers and is essentially paid for by the advertisements placed in the shows that are watched. Even in cable television systems and satellite-based systems, the revenues from advertisements subsidize the cost of programming, and were it not for advertisements, the monthly subscription rates for cable television would be many times higher than at present. Radio similarly offers free programming based on payments for advertising.

Techniques for inserting pre-recorded messages into broadcast transmission have been known. Generally, broadcast video sources (i.e., TV networks, special interest channels, etc.) schedule their air time with types of information: “programming” for the purpose of information or entertaining, and “avails” for the purpose of advertising. The avails are time slots that may occupy roughly 20-25% of the total transmitting time and are usually divided into smaller intervals of 15, 30, or 60 seconds. Avails are offered based on the target demographics of the end user. These demographic factors advertisers consider in placing an advertisement include location, target audience, and reach.

These broadcast content providers either provide their content directly to consumers, or through the use of local affiliates. Avails are thus sold at a national, regional, or local level, either by the content provider or the local affiliate which ultimately airs the content in the local market with the sold avails inserted into the content.

Because of the global nature of the internet, the advertising markets of traditional broadcasts are non-existent. Thus because there are no markets, it is difficult to duplicate the existing model of providing avails based on the same demographic information considered in traditional broadcasting. Content providers have thus faced a challenge in distributing their media over the internet, because it has not been possible to duplicate the advertising model of broadcast media over the internet.

Because content providers have not been able to duplicate the traditional broadcast model using the internet, content providers have utilized revenue models involving one of three mechanisms for content distribution over the internet: 1) Subscription based, were the content provider charges a monthly fee for content; 2) pay per view, where the content providers charge per each access to content; or 3) global advertising, in which the insertion of an advertisement is non-geographically targeted, and merely tags along with whatever content is distributed. An exemplary attempt to provide an advertisement system for subscriber based systems is disclosed in U.S. Patent Application Publication 2004/0148625, dated Jul. 29, 2004 by Eldering et al.

There are severe limitations to these mechanisms. First, these strategies compete with the content provider's traditional and primary broadcast medium content, where they present a scenario where an undervalued alternative to their content is available and risks eroding viewer-ship and advertising revenue of their traditional broadcast source. Second, the subscription model is adoption-prohibitive, meaning that users are reluctant to pay for content that is available for free in another offline medium.

As the proliferation and adoption of broadband internet connectivity continues to increase, and the popularity of streaming media, on-demand viewing, “podcasting” and “vidcasting” continue to expand, content providers are challenged to meet consumer demand and find a profitable business model of internet distribution that complements existing offline broadcast models.

Several definitions of terms used in this specification may be helpful to a reader. As used in this specification:

“Podcasting” means providing audio files for download from a provider's website via the internet to a user device such as an Ipod or laptop to be played by a user.

“Vidcasting” means providing video files for download via the internet from a provider's website to a user device such as an Ipod or laptop for users to play on demand.

“Multimedia” and “media” mean any audio data and video data, whether digital or analog, designed to be played together on a user device. “Multimedia” and “media” are used interchangeably in this specification.

“Streaming media” means real-time multimedia content transmission to a user device over the internet where the content is immediately played as it is received.

“Download” means a data file destined to be fully downloaded to a user device prior to being played on the user device.

“User device” means any device capable of playing a multimedia file or files, such as an MP3 video-player, video Ipod, a personal computer, laptop computer, cellular phone, internet connected set-top box, or personal digital assistant (PDA).

### SUMMARY

The present disclosure provides a solution to the above identified problems and limitations with content provided via the internet as well as achieving other objectives.

One embodiment in the present disclosure is a method for providing targeted advertising material in multimedia content to a user device via the internet. This method includes operations of receiving a request for multimedia content from a user device via the internet, determining geo-location information about the user device, and retrieving the requested media content along with user demographic information. The content included user demographic information is combined with the geo-location information about the user device to provide a user profile. Then at least a first advertisement database is queried for advertising material matching one or more characteristics of the demographic information about the user and/or the user profile. If there is a matching advertisement found, the matching advertising material is retrieved from the first database, and inserted into the retrieved media content. The retrieved multimedia content, along with the matching advertising material, is then transmitted to the requesting user device over/through the internet.

Preferably the content is broken into segments between which the advertising material is placed. The content may also have empty avail space between each content segment, similar to traditional broadcast method formats. If multiple advertisements are identified, these may be interspersed between the segments of content. The retrieved content and advertising material is then preferably compiled into a single file for transmission via the internet to the requesting user device.

The first advertisement database preferably includes advertising material provided by the provider of the media content. A second database may be queried as well, for example, to provide geographically specific advertisements based on the geo-location information about the user's user device. Such a second database would preferably contain advertisements of a content provider affiliate in a local geographic market, such as, for example, Phoenix, Ariz. A third database may also be queried that contains additional advertising material for use where the first and second database advertisements have not preempted the permissible advertising space available with the content. These databases may be integrated into a single database.

For example, if no content provider matching advertising material is initially identified that is to be inserted regardless of geo-location, the first database or another database is queried for advertising material matching a geo-location corresponding to the requesting user. The advertising material matching the geo-location of the requesting user is then inserted into the retrieved media content. Finally, the inserted advertising material and media content are preferably compiled into a single file prior to sending the file to the requesting user's device.

One embodiment of the disclosure is a system for providing targeted advertising material in multimedia content to a user via the internet in response to a user's request for media content on a content provider's website. This system preferably includes a processing module receiving the user's request for media content from a user device via a content provider's website on the internet, a geo-location module determining geo-location information about the user device, a content retrieval module obtaining the requested multimedia content along with user demographic data provided by the content provider, an advertisement database, a search module searching the database for advertising material matching a characteristic of the demographic information about the user and an insertion module inserting any matching advertising material into the retrieved media content. Finally the system preferably includes a compiler converting the multimedia content and matching advertising material into a single file for transmission to the requesting user device over the internet.

In addition, the system preferably includes a transaction module operable to track content download or streaming requests, delivery statistics, and process payment information. Further, the content provider preferably provides, in addition to the content in the content database, limitations as to the type and number of advertisements that may be incorporated into the requested content. The content provider thus preferably can control the total number of ads and the proportion of spot, affiliate and network provided ads that may be incorporated into a particular requested content file being downloaded or streamed to the user's device.

### DRAWINGS

The above-mentioned features and objects of the present disclosure will become more apparent with reference to the following description taken in conjunction with the accompanying drawings wherein like reference numerals denote like elements and in which:

FIG. 1 is a simplified schematic block diagram of an embodiment of the system in accordance with the present disclosure.

FIG. 2 is simplified block diagram of the operational modules in the system in accordance with the embodiment of the system shown in FIG. 1.

FIGS. 3 and 4 together form a process flow diagram of one method of operating the embodiment of the system shown in FIG. 1.

FIG. 5 is an exemplary simple composite user profile for an exemplary multimedia content in accordance with the present disclosure.

FIG. 6 is a visual representation of the compiled file containing ads and content for download to a requesting user device.

FIG. 7 is a simplified process flow diagram of the process for placement of an advertisement to the system in accordance with an embodiment of the present disclosure.

FIG. 8 is a simplified process flow diagram of advertisement identification upon a user's request for content in accordance with an embodiment of the present disclosure.

FIG. 9 is a simplified process flow diagram of advertisement placement in content and delivery to a user device in accordance with an embodiment of the present disclosure.

FIG. 10 is a simplified process flow diagram of a transaction fulfillment process for the requested content in FIGS. 8 and 9.

### DETAILED DESCRIPTION

The operations of the exemplary embodiment of the present disclosure set forth below may be implemented (1) as a sequence of computer implemented acts, operations, or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

All patents, published patent applications and other printed publications referred to herein are hereby incorporated by reference in their entirety.

An exemplary embodiment described below enables content providers to distribute their television and radio content over the internet while retaining the profitable and time proven method of market based broadcasting and advertising. This is preferably accomplished by first segmenting the internet audience into localized markets using geo-location technology. This technology may involve triangulation of transmission signals from a user device, or may use a requesting user's device IP address to identify their location in an approximate fashion, for example. This information may also be provided by a content provider's own database of known users that contains geo-location information where available. Secondly, the content provider/owners specifies the target audience information associated with their content, i.e., perceived user demographics (age, income, etc.). This audience information, or user demographics, is combined to yield a user demographic profile that then is used to match advertisements from one or more databases to be inserted into the multimedia content. The content owner/provider also preferably specifies the number of, position of, exclusion of, and selection criteria for advertisements that may be incorporated into its content.

A content owner may choose to incorporate their own advertisements (ads), commonly referred to as “commercials”, into the content, or may allow business logic based on the demographics of the requesting user to automatically choose from a localized affiliate database of available commercials or a general posting database of commercials. These latter advertisements are often referred to as “spot” buys.

If the content owner selects the second option, i.e., allow automatic business logic to select advertisements, they can control the types of advertisements, advertisers, set the minimum rates per transmission, and control the markets the ads are shown in so a commercial that is unfavorable to their business name is not automatically selected. As an example, a GM ad may not be selected to accompany a show that Ford has produced with CBS.

The content provider/owner can also do a blended approach, choosing to run their own ads in certain markets, but, in markets for which they don't have their own ads, they can allow the system to select an advertisement. The uniqueness of this arrangement is that typically content providers and/or content owners, e.g., a broadcast network such as CBS, have local affiliates that control the advertisement buys in their locations. Thus, content providers can provide their own ads, allow their affiliates to provide ads, or buy ads on the “spot” market through the advertisement database in the present disclosure. For example, a CBS affiliate in Phoenix, Ariz. will run Phoenix ads, etc., to user devices in the Phoenix locale. This allows the content provider to distribute content and advertisements that they have booked and that their affiliates have booked, but also allow the system to automatically insert advertisements in localities where they currently have no advertisements booked such as in Paris, France, for example.

The content and ads are compiled preferably into a single file—on a transaction basis (as the user requests the file)—and the compiled content can be either downloaded or streamed to the user device. Content owners can distribute their content as a downloadable file or streaming content, transmitted as a live event, archived for on-demand, or timed to play in different time zones.

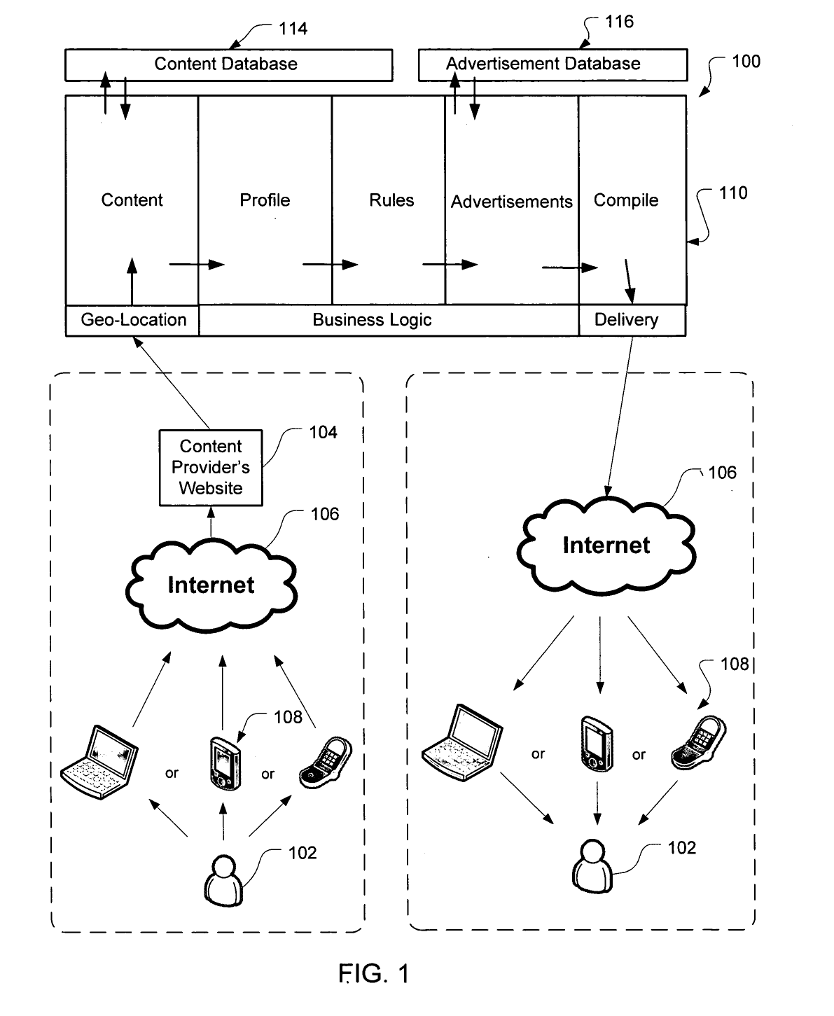

A conceptual block diagram of one exemplary embodiment of the system 100 in accordance with this disclosure is illustrated in FIG. 1. When a user 102 requests content from a content owner's website 104 via the internet 106 using a user device 108, he or she would either click on a hyperlink that points to the server 110 or activate an embedded video player on the content provider's website 104 that references the server 110. When the request is made the system 100 first calls a geo-location engine 112 to determine an approximate location of the user device 108. This information may, for example, be obtained from the request header, e.g., the IP address, etc. Concurrently, the system queries a content database 114 to retrieve the requested multimedia content along with corresponding content, geo-location restrictions, if any, demographic values and content rules, or parameters. These content rules or parameters define the restrictions and rules for advertisement insertions provided by the content provider. Second, the system 100 analyzes the rules of the content (e.g., whether the system 100 is to provide an advertisement that has already been predefined by the content owner, select an advertisement from a local affiliate, or select an advertisement automatically from the database 116. These parameters and rules also preferably provide bounding criteria for maximum number of advertisement insertions, frequencies, etc.). Third, the system 100 queries one or more advertisement databases 116 to retrieve advertisements that match the rules or criteria provided by the content provider, affiliate, and geo-location information for the user device 108. Finally, the system 100 preferably compiles or concatenates the ad(s) and the multimedia content to a single file that is then either streamed or downloaded to the user device 108. This is important because there is only 1 file the user streams or downloads, with the advertisements embedded between sequential segments of the content. The end user's user device 108 may be any device that has the capability of accessing a content provider's website 104, such as a laptop, a personal computer, a cell phone, an internet connected set-top box or a PDA. Each of these devices must have a capability of displaying/providing a media player functionality. Multi-media is viewed through a media player. The user 102 thus can play the file as a multimedia program tailored in a similar manner as if the user 102 were watching a television or listening to a radio broadcast through traditional broadcast mediums in their specified geographic location.

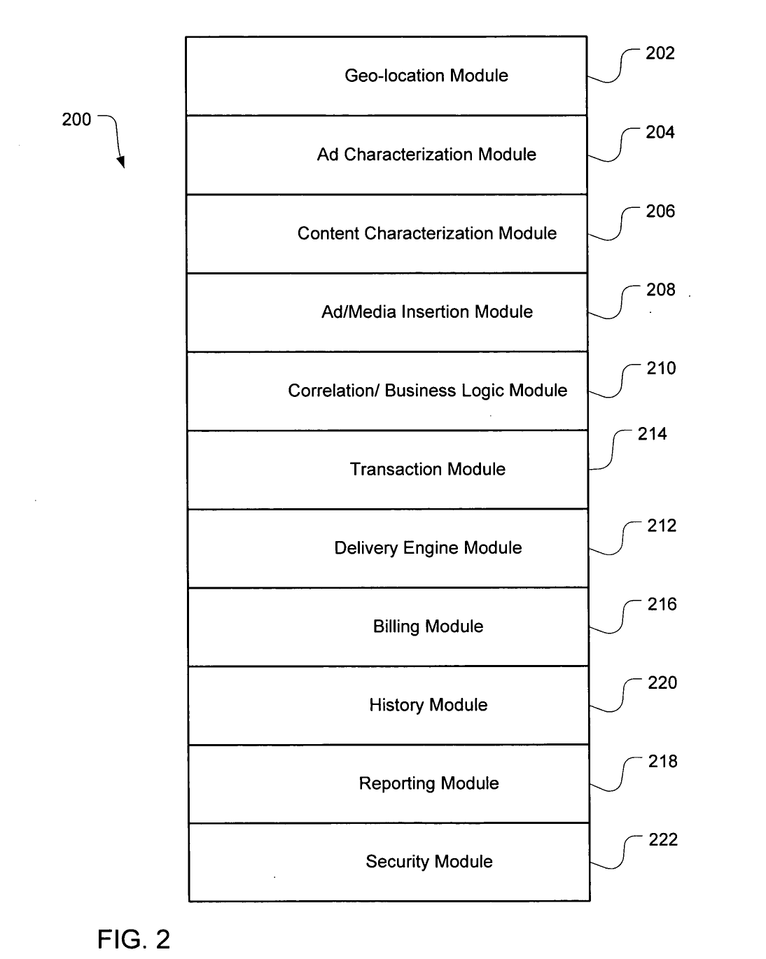

One preferred embodiment of the system 100 residing on the server comprises a series of interconnected functional software modules as shown in FIG. 2. Fundamental to the system 100 are a Geo-location Module 202, an Ad Characterization Module 204, a Content Characterization Module 206, an Advertisement/Media Insertion Module 208, a Correlation/Business Logic Module 210, and a Delivery Engine Module 212. The system 100 also includes support modules such as a Transaction module 214, a Billing Module 216, a Reporting Module 218, a History Module 220, and a Security Module 222. Each of these modules interfaces with one or more of the other modules as described below.

The Geo-location Engine Module 202 determines the location of a user's user device, and hence the approximate location of the user. This module may utilize the internet protocol address of the user device, the IP node through which the user device accesses the internet, wireless signal triangulation techniques, or other technique as appropriate to the particular user device. For example, if the user accesses the internet through a cell phone to transmit a content request, a wireless signal triangulation technique may be utilized. In fact, such information may already be encoded into the transmission signal from the cell phone. If the user is accessing the internet through a wireless or wired hotspot or other localized access point, the IP address of the hotspot will most likely suffice to provide geo-location information for purposes of the present disclosure. A precise geo-location of the user device is not generally required. For example, if the user device can be localized to a particular town or city that will generally be sufficient, although precise location information could conceivably be utilized to target very specific advertisements in accordance with the present disclosure. For example, if it were known that the IP address reflected a Starbucks outlet location, a Starbucks advertisement could be given preferential position.

The Ad Characterization Module 204 allows an advertiser to upload or provide their multimedia advertisement along with demographic criteria, and type of advertisement restrictions such as live only, on-demand, timed, or download. The advertisements are stored to one or more advertisement databases generally indicated as database 116. This module 204 also provides posters of advertisements to associate their ads with only certain content producers such as the sponsor network (e.g., CBS).

The Content Characterization Module 206 allows content providers/owners to upload or otherwise provide their multimedia, define and associate demographic information with each item of multimedia content, define the type of content item (e.g., timed, live, on-demand, and, if live or timed, enter date/time data). This module 206 also provides for placement rules such as the conditions required for ad placement such as requiring exclusion of other identified advertisers, inclusion of certain sets of advertisements, set price requirements for spot placement, associate or place available advertisements, and define limitations on the number and distribution of ads within the specific content item.

The Correlation Module 208 contains algorithms and rules that determine the actual placement of ads into a requested multimedia content item (e.g., provided ads or spot matches with either affiliates or general advertisements).

The Insertion Module 210 operates to concatenate, i.e., link identified and selected ads within a selected content item based on instructions from the correlation module 208.

The Delivery Engine Module 212 receives the concatenated multimedia content and compiles the concatenated content preferably into a single file and delivers the final single file through the internet 106 to the user device 108 for play by the user 102. The Delivery Engine Module 212 also provides input data to the transaction Module 214, the Billing Module 216, the history Module 218, Reporting Module 220 and Security Module 222 described below. Alternatively, the function of compilation may be incorporated into the Insertion Module 210. In this instance, the Delivery Engine Module 212 would simply deliver the final single file and provide input data as above described.

The Transaction Module 214 registers each and every content request/delivery occurrence along with monitoring which advertisements, and how many, were incorporated into the content, and whether the delivery was by download, streaming, live or on-demand.

The Billing Module 216 communicates with the Transaction Module 214 and facilitates financial tracking, payment, payment of residuals for content downloaded for play, payment requisition, and accounting functions related to each transaction, i.e., content request/delivery occurrence.

The History Module 220 maintains and logs content type, ads sent, and tracks repeat user transactions/occurrences. The data compiled in the History Module may be used to enhance demographic categorizations utilized by the content providers and others tracking trends in usage.

The Reporting Module 218 generates reports for advertisers and content providers on a periodic basis. The transactional modules 214, 216, 218 and 220 may be interleaved into one overall transactional function module rather than being separate as shown in FIG. 2 since many of their functions are related to tracking and monitoring operation of the system 100.

The Security Module 222, however, is important on several levels. First, the Security Module 222 preferably provides mechanisms in the downloaded or streamed content to prevent the user 102 from stripping out embedded advertisements from the multimedia content received in the user device 108. Essentially this module prevents unauthorized file tampering and permits only content play on the user device 108 from which the content was requested. Second, the security module 222 may provide a mechanism for preventing a user from distorting ad impressions to preclude false billings to the advertisers with consequent inflated payments to the content provider. This module 222 may also incorporate a digital rights monitoring and tracking function to track ownership of digital material.

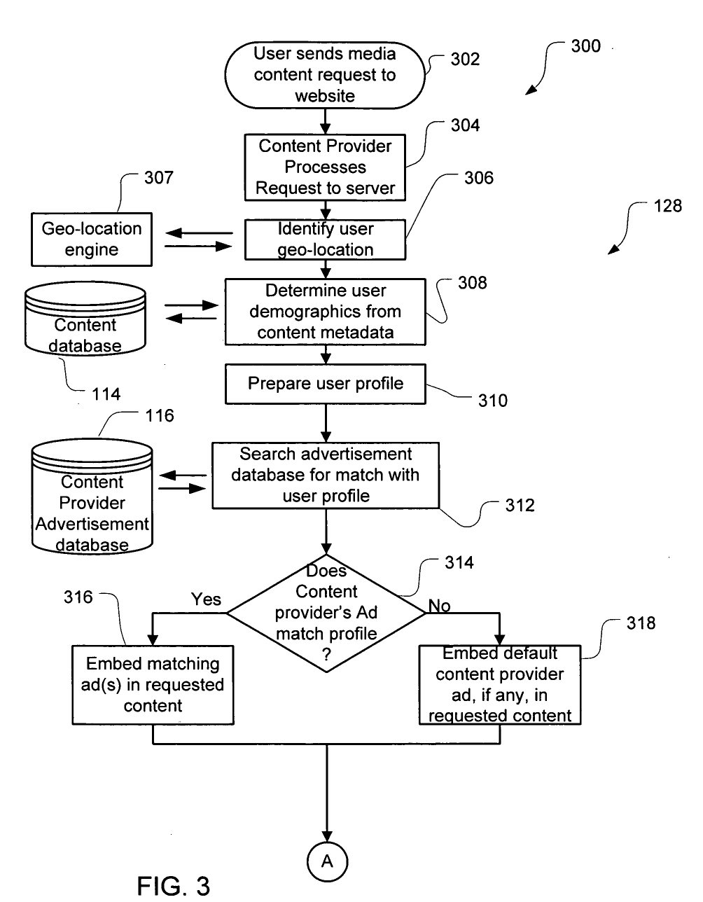

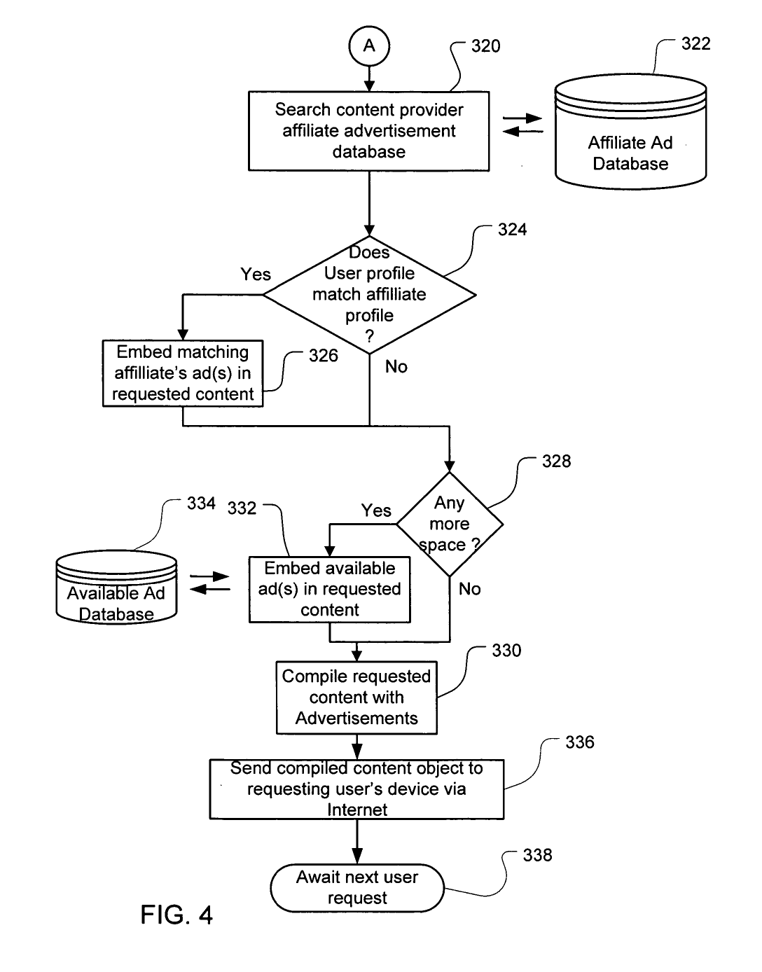

FIGS. 3 and 4 together show on a block diagram level, the process flow 300 of operations in accordance with the embodiment of the present disclosure shown in FIGS. 1 and 2.

When a user 102 views a website 104, the user is typically presented with a variety of information, choices, links, etc. If and when a user 102 viewing the website clicks on an item that operates to request an item of content, control transfers to operation 302 where a media content request is issued from the content provider's server to the system 100 in accordance with the present disclosure. When the request in operation 302 is issued, control transfers from the content provider's server in operation 304 to system 100, identity operation 306. In operation 306 the request from the content provider is processed, the user device 108 type is identified, and a control signal is sent to an appropriate geo-location engine 307. The particular engine 307 that is utilized depends on the type of user device 108. Operation 306 determines which type of engine 307 is to be used. Engine 307 is conventional third party software that determines the approximate geo-location of the user device 108. For example, a triangulation method may be utilized in engine 307 where the user device 108 is a cell phone and sufficient information was included with the request, or by receiving the information from the cell phone provider directly. Alternatively, if the user device 108 is a laptop connecting to the internet through a web portal, for example, an IP address of the requesting node could be used to localize the request. Once the geo-location engine 107 returns a geo-location for the user device 108, process control transfers to operation 308.

In operation 308, the requested content is retrieved from the content database 114. Along with the content, associated rules, parameters and codes are retrieved that define the number and type of advertisements, appropriate user demographics, preferred geo-location, and any other restrictions on ad insertions that may be applied to the particular requested content. Control then transfers to operation 310.

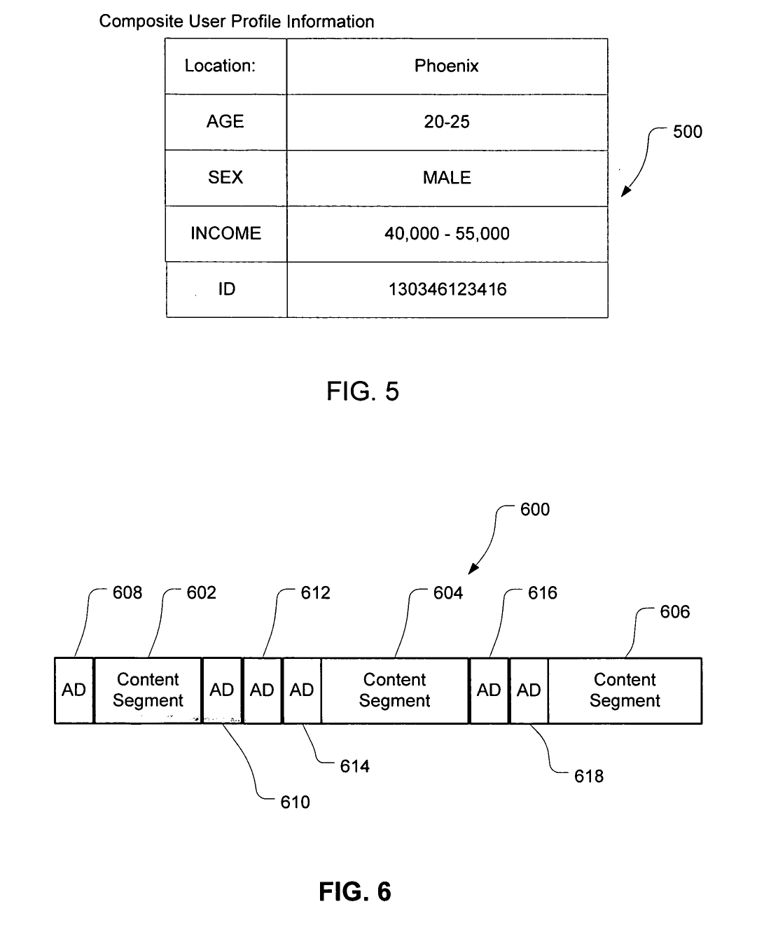

In operation 310, the content metadata retrieved in operation 308 is combined with the user device 108 geo-location information determined in operation 306 to generate a user profile. An example 500 of such a user profile is shown in FIG. 5. However, not shown are other parameters particularly associated with the content itself, such as the number of segments that the content may be divided into, the number and location of ads between each segment, etc. That information is tied to the content itself. Control then transfers to operation 312.

In operation 312, a content provider advertisement database is searched to determine if there are any advertisements that match the user profile 500 developed in operation 310. If there are any matching advertisements, these are retrieved and temporarily stored in active memory. Control then transfers to query operation 314.

In query operation 314 the question is asked whether there is a content provider's advertisement matches a required number of parameters in the user profile. If the answer is yes, control transfers to operation 316 where the matching ad or ads are queued for insertion into the requested content, assuming the content parameters permit insertion. On the other hand, if the content provider's ads do not match the required one or more parameters of the user profile, then control transfers to operation 318 where, if there are any identified default content provider ads identified, these are queued for insertion into the requested content. For example, say a content provider has stored a first advertisement for use whenever that provider's content is requested and a second ad that is to be used only for a user demographic of age 15-25. If, in operation 310, the retrieved content is geared for 15-25 year olds, then both of these ads would match, and would be queued for insertion into the content. However, if the content provider had no advertisements in the database to be used in every case, or not enough advertisements, and the user profile associated with the content was age 55+ (such as perhaps a piece from the History Channel content), then no matching ad would be found and a default content provider ad, if any, could be queued for insertion in operation 318.

Control then passes to operation 320. Here a search is made of any content provider affiliate database 322 based on the geo-location determination back in operation 306. A content provider affiliate, for example, might be a CBS affiliate in Phoenix, Ariz., if the content provider is CBS. It should be understood that the advertisement database 116 may encompass each of the ad databases described herein or each may be separately compiled. Control then transfers to query operation 324.

In query operation 324, the question is asked whether the retrieved affiliate ad or ads match the user profile determined in operation 310. If there is a match, control transfers to operation 326 where the affiliate's ad or ads are queued for embedding in the requested content. If, on the other hand, the user profile does not match the affiliate profile, control passes to query operation 328 without queuing affiliate advertisements.

In query operation 328, the query is made whether the retrieved content may contain any more advertisements. If the answer is yes, control transfers to operation 332. If the answer is no, control transfers to operation 330.

In operation 332, a database 334 of available “spot” ads is searched and ads retrieved according to space left available. Preferably spot ads are placed based on a relative level of matching between the ad and the user profile, i.e., a match considering both geographic and demographic. For example, the top level of match may only be 20%. These may alternatively be essentially “filler ads, with no special criteria, except, perhaps, matching geo-location criteria. They are preferably not affiliated in any way with the content provider or its affiliates. Both geo-location information and demographics are preferably considered, however. In sum, preferential treatment is given first to the content provider's own and its affiliate's advertisements before the spot ads. Control then transfers to operation 330.

In operation 330, all of the queued advertisements are embedded in the requested and retrieved content provider's content, in between consecutive content segments defined by the content provider. A visualization example of an item of content 600 with advertisements interspersed is shown in FIG. 6. This composite content would be played by a user 102 on a media player in the user device 108 after transmission, or during, in the case of streaming media. The composite content 600 in this illustration has three sequential segments 602, 604 and 606. At the beginning a content provider specified ad 608 is positioned to play first. After content segment 602 a content provider affiliate advertisement 610, for example, an affiliate in Phoenix, is provided. Next a demographic matched advertisement 612 is followed by another content provider specified advertisement 614. The second content segment 604 is followed by a content provider specified advertisement 616 and then, finally, a matched geo-location advertisement is placed. This is followed by the final third segment of the requested content 606.

In operation 330 this composite content is assembled and compiled into a single file for transmission to the user device 108. Control then transfers to operation 336. In operation 336, the requested file is downloaded, streamed, or otherwise transmitted or queued for transmission to the user device 108. In addition, this operation sends data to each of the reporting and transaction modules 214 through 220 so that the transaction, i.e., the requested content and its delivery can be tracked and billed to the proper advertisement or content source.

Finally, control transfers to operation 338 where the system 100 is reset to await another user request from a content provider's website. It should be understood that the operations 300 may preferably be performed by the system 100 on distributed machines such that many requests may be simultaneously handled and processed in order to timely meet the demands of users and content providers alike.

Further, the sequence of operations 302 through 336 may be continuously repeated as needed to maintain a flow of contiguous streaming of compiled files if a user request, for example, is for streaming live broadcast multimedia content. in such a case, near the end of one compiled content file would be a flag or other coded indication to signal compilation of the next file for sequential delivery. For example, if the user 102 issues a request on a content providers website 104 to watch MSNBC during Hardball, the system 100 would compile ads with the MSNBC content file and stream the file to the user device 108 as above described, and would then repeat the sequence of operations for the next MSNBC program in sequence. Control, in this situation would invoke operation 338 whenever a termination signal is received from the user device 108. If such a termination signal is not received, the stream could continue uninterrupted with the operations 302-336 in system 100 repeated as each live broadcast program occurs.

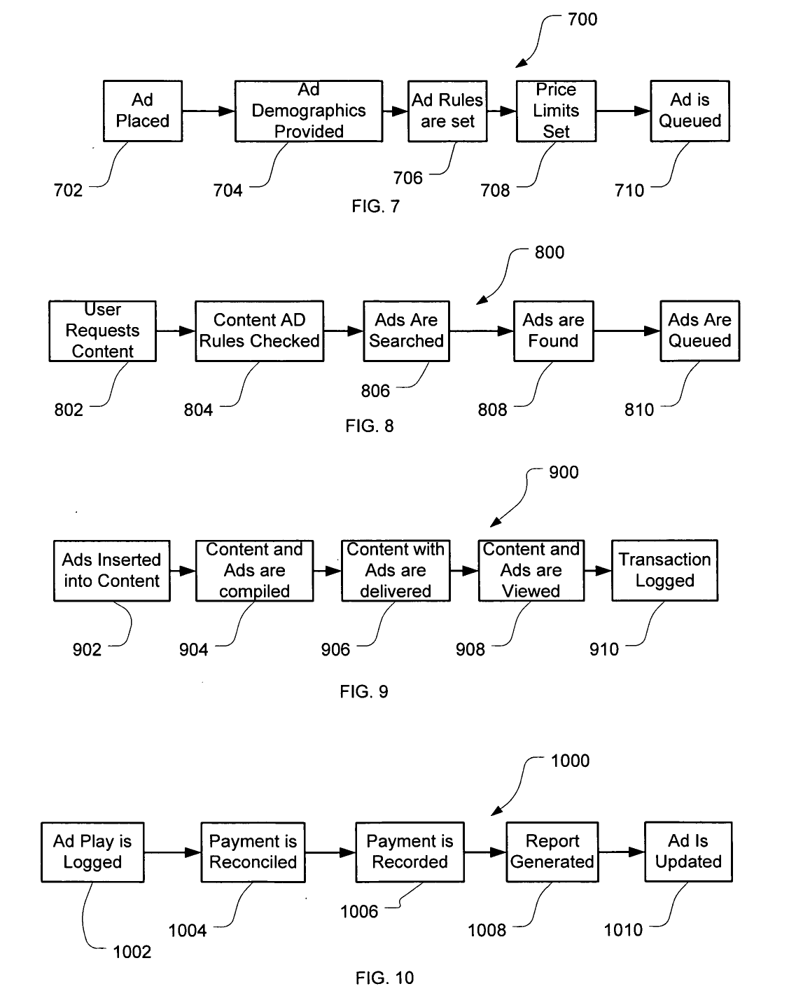

FIG. 7 is a block diagram of the ad placement operations that the operator of the system 100 accomplishes to place an advertisement, i.e., commercial, into the database 116, which constitutes an advertisement “buy” function. This ad buy applies as well to database 322 and 334. The process 700 begins with operation 702 where the advertisement is provided or accessed for upload into the database. In operation 704, the demographics metadata are provided by the advertiser. These metadata may include a geo-location requirement, as well as other demographic information such as shown in FIG. 5. The selection rules are then set in operation 706. These rules govern how, where and when the advertisement is placed in a content file. Next the pricing parameters are set. These pricing parameters may include price limitations depending on the positioning in the content, where the advertisement is placed. For example, a higher price may be charged for ad placement ahead of the first segment of content, or just ahead of the last segment of the content. Finally, the advertisement, along with its associated metadata, rules and limitations, is compiled and queued into the database 116. It is to be understood that databases 322 and 334 may be incorporated into, and exist as a part of, database 116 throughout this discussion.

FIG. 8 is a summary block diagram 800 of the system 100 ad selection function upon receiving a user request for content to determine the ads to be queued. First, a user requests content in operation 802. Next, in operation 804, the content is retrieved and content ad rules are checked to determine what ads may be compiled with the content, where they are to be placed, and how many ads may be included. Next, in operation 806, the databases 116, and, if separate, databases 322 and 334 are searched. Matching ads are found in operation 808 and queued for eventual insertion in operation 810.

FIG. 9 is a summary block diagram 900 of the system 100 advertisement delivery function. Once all the advertisements permitted by the content provider to be associated with the requested content are queued, the queued ads, in operation 902i, are inserted, or otherwise collated, at their requisite segment locations in the content. Then, in operation 904, the content and ads are compiled into a single file for delivery to the user device 108. In operation 906, the ads are viewed by the user 102 via the user device 108, and the completed transaction is logged in operation 910. Once the compiled file has been transmitted to the user device 108, it is preferably assumed that the content and ads are viewed.

FIG. 10 is a summary block diagram of one exemplary embodiment of the transaction fulfillment function 1000 in the system 100. When the content and ads are delivered, and played, (play is assumed), a delivery of each of the advertisements compiled with the transmitted content is logged in operation 1002. Then, on a periodic basis, the fee payment required is reconciled in operation 1004. When the advertiser submits payment to the content provider, payment is recorded in operation 1006 and periodically a transaction report generated in operation 1008. Finally, the advertiser may update the advertisement metadata in operation 1010 based on a review of ad placement frequency, changes in perceived demographics, etc.

While the apparatus, system and method have been described in terms of what are presently considered to be the most practical and preferred embodiments, it is to be understood that the disclosure need not be limited to the disclosed embodiments. The system 100 may be implemented on a variety of hardware/software platforms utilizing a variety of development languages, databases, communication protocols and frameworks as will be evident to those skilled in the art. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for providing targeted advertising material in media content to a user device via the internet comprising:
receiving a request for media content from a user device via the internet;
determining geo-location information about the user device;
retrieving the requested media content along with user demographic information;
querying a first advertisement database for advertising material matching a characteristic of the demographic information about the user;
retrieving matching advertising material, if any;
inserting the matching advertising material into the retrieved media content; and
transmitting the media content with the matching advertising material to the requesting user device.

2. The method according to claim 1 wherein the inserting operation comprises interleaving the advertising material in the retrieved content and compiling the interleaved advertising material and content into a single file.

3. The method according to claim 1 wherein the first advertisement database comprises advertising material provided by a provider of the media content.

4. The method according to claim 3 wherein the first advertisement database comprises advertising material required to be sent to a user with retrieved media content provided by the content provider.

5. The method according to claim 1 further comprising, if no matching advertising material is identified, querying the first database or another database for advertising material matching a geo-location corresponding to the requesting user.

6. The method according to claim 5 wherein the advertising material matching the geo-location of the requesting user is inserted into the retrieved media content.

7. The method according to claim 1 further comprising querying another database for advertising material matching a geo-location of the requesting user and inserting a geo-location matching advertisement into the media content in addition to the content provider matching advertising material.

8. The method according to claim 7 further comprising querying a third database for advertising material to be inserted into the media content in addition to the content provider matching advertising material and geo-location matching advertising material.

9. The method according to claim 8 further comprising compiling the advertising material and media content into a single file prior to sending the file to the requesting user's device.

10. A system for providing targeted advertising and media content to a user requesting media content from a content provider over the internet, the system comprising:
means for receiving a request for media content from a user device via the internet;
means for determining geo-location information about the user;
means for retrieving the requested media content with user demographic data;
means for querying a first advertisement database for advertising material matching a characteristic of the demographic information about the user;
means for retrieving matching advertising material;
means for inserting the matching advertising material into the retrieved media content; and
means for transmitting the media content to the requesting user device.

11. The system according to claim 10 wherein the means for receiving comprises a server connected to the internet and to a content database and to at least the first advertisement database.

12. The system according to claim 11 wherein the means for querying comprises a set of instructions residing on the server comprising a set of rules provided by an advertiser.

13. A system for providing targeted advertising material in multimedia content to a user via the internet in response to a user's request for media content on a content provider's website, the system comprising:
a processing module receiving the user's request for media content from a user device via the internet;
a geo-location module determining geo-location information about the user device;
a content retrieval module obtaining the requested multimedia content with user demographic data provided by the content provider;
an advertisement database;
a search module searching the database for advertising material matching a characteristic of the demographic information about the user;
an insertion module inserting any matching advertising material into the retrieved media content; and
a compiler converting the multimedia content and matching advertising material into a single file for transmission to the requesting user device.

14. The system according to claim 13 further comprising a transaction module tracking ad play and processing payment information.

15. An apparatus for advertising in multimedia content distributed over the internet, the apparatus comprising:
a processor;
a memory coupled to the processor storing instructions adapted to be executed by the processor to:
receive a request for multimedia content from a user device via the internet;
determine geo-location information about the user device;
retrieve the requested multimedia content with user demographic data;
query a first advertisement database for advertising material matching a characteristic of the demographic information about the user;
retrieve matching advertising material;
insert the matching advertising material into the retrieved multimedia content; and
transmit the multimedia content to the requesting user device.

16. The apparatus according to claim 15 wherein the insert operation comprises interleaving the advertising material in the retrieved content and compiling the interleaved advertising material and content into a single file.

17. The apparatus according to claim 15 wherein the first advertisement database comprises advertising material provided by a provider of the multimedia content.

18. The apparatus according to claim 17 wherein the first advertisement database comprises advertising material required to be sent to a user with retrieved multimedia content provided by the content provider.

19. The apparatus according to claim 15 wherein the instructions, if no matching advertising material is identified, query the first database or another database for advertising material matching a geo-location corresponding to the requesting user.

20. The apparatus according to claim 19 wherein the advertising material matching the geo-location of the requesting user is inserted into the retrieved multimedia content.

21. The apparatus according to claim 15 wherein the instructions further query another database for advertising material matching a geo-location of the requesting user and insert a geo-location matching advertisement into the media content in addition to the content provider matching advertising material.

22. The apparatus according to claim 21 wherein the instructions further query a third database for advertising material to be inserted into the media content in addition to the content provider matching advertising material and geo-location matching advertising material.

23. The method according to claim 22 wherein the instructions compile the advertising material and media content into a single file prior to sending the file to the requesting user's device.
